(19) United States
(12) Patent Application Publication
(10) Pub. No.: US 2005/0141355 A1
(43) Pub. Date: Jun. 30, 2005

(54) Optical disk drive with anti-swing tray and method thereof

(75) Inventor: Chen-Jung Chen, Taipei City (TW)

Correspondence Address: BIRCH STEWART KOLASCH & BIRCH, PO BOX 747, FALLS CHURCH, VA, 22040-0747, US

(73) Assignee: ASUSTek COMPUTER INC.

(21) Appl. No.: 10/978,419

(22) Filed: Nov. 2, 2004

(30) Foreign Application Priority Data
Dec. 31, 2003 (TW) 92137615

(51) Int. Cl. G11B 7/085

(52) U.S. Cl. 369/30.27

(57) ABSTRACT

An optical disk drive with anti-swing tray and method thereof. In order to reduce swing of the tray of the optical disk drive when the tray is opened, a first driving signal is applied to a driving module of the optical disk drive to move the tray from a first position to a second position. A calibrating signal is then applied over a predetermined time period to the driving module to correct the position of the tray.

### BACKGROUND

The invention relates to a short optical disk drive, and in particular to a short optical disk drive with a horizontal anti-swing tray.

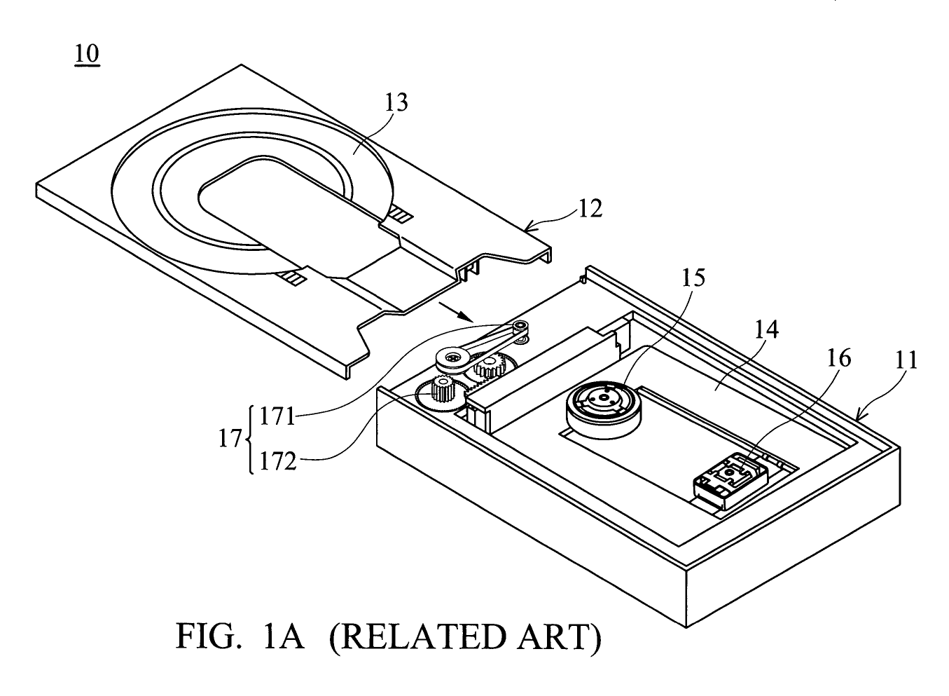

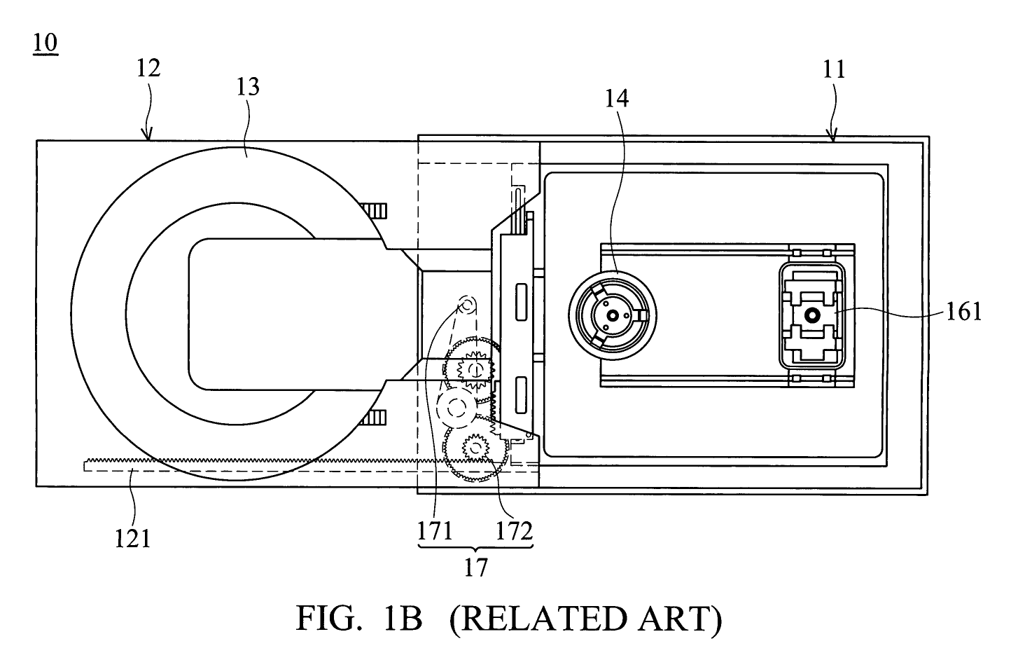

FIG. 1A is a perspective view of a conventional optical disk drive. In FIG. 1A, the conventional optical disk drive 10 has a main body 11 and a tray 12. The tray 12 has a recess 13 for receiving optical disks. The main body 11 of the optical disk drive 10 has a carrier 14 and a driving module 17. A spindle motor 15 and a pickup head 16 are disposed on the carrier 14. The driving module 17 comprises a motor 171 and a gear assembly 172 to drive the tray 12. After the driving module 17 moves the tray 12 holding an optical disk into the main body 11 and lifts the carrier 14, the spindle motor 15 rotates the optical disk, and data is read therefrom or written thereto by the pickup head 16.

FIG. 1B shows a conventional optical disk drive with the tray ejected. In FIGS. 1A and 1B, the tray 11 of the optical disk drive 10 comprises a rack 121 on one side of the reverse surface. The motor 171 is capable of driving the tray 12 on one side through the gear assembly 172 and the rack 121. The other side of the tray 12 is passively moved, such that sufficient gaps between the tray 12 and main body 11 are required to ensure the tray 12 can be moved smoothly.

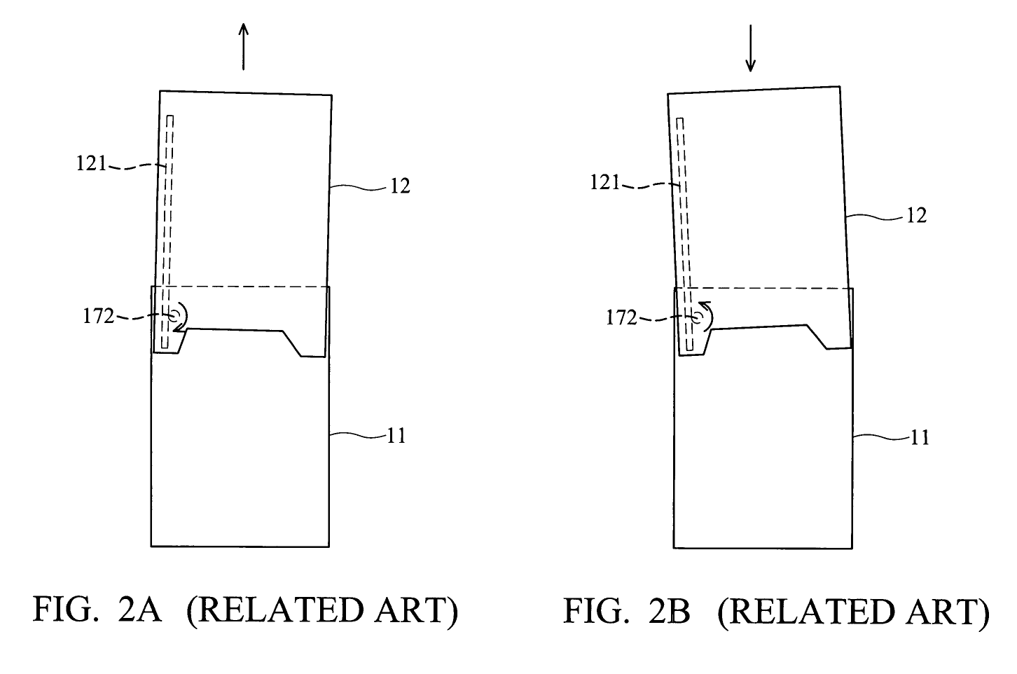

The left side of the tray 12 moves faster than the right side (passive side) because the tray 12 is driven by the driving module 17 on the left side (active side) when ejected. Thus, the tray 12 tilts rightward by a small angle as shown in FIG. 2A during ejection. When the motor 171 reverses to receive the tray 12, the left side of the tray 12 is immediately inserted, but the right side of the tray 12 remains motionless. Thus, the tray 12 swings leftward by a small angle as shown in FIG. 2B when inserted.

A sufficient portion of the tray 12 remains in the main body 11 when the tray 12 is open because the main body 11 and tray 12 of a conventional optical disk drive 10 are longer enough. The tilt angle of the tray 12 is very small, such that the horizontal swing problems described above are not apparent in conventional optical disk drives.

Currently, optical disk drives are, however, shortened to reduce required space in device housings. Only a short portion of the tray remains in the main body when the tray is open because the main body and tray of a conventional short optical disk drive are shortened. Thus, the gap between the tray and main body at the passive side is magnified, causing the tray to tilt rightward by a relatively larger angle, increasing jitter and noise when closing the tray.

### SUMMARY

An embodiment of the invention provides a method for reducing the tray swing of a short optical disk drive when the tray is opened.

Accordingly, in order to reduce swing of the tray of an optical disk drive when the tray is opened, a first driving signal is applied to a driving module of the optical disk drive to move the tray from a first position to a second position. A reverse second driving signal is then applied to the driving means over a predetermined time period to correct the position of the tray when the tray arrives in the second position.

An optical disk drive of an embodiment of the invention comprises a tray, driving means, and control module. The driving means comprising a motor and a gear assembly moves the tray between a first position and a second position. The control module comprising a microprocessor 291 provides a first driving signal to the driving means to drive the tray from a first position to a second position, and provides a reverse second driving signal to the driving means over a predetermined time period to correct the position of the tray when the tray arrives in the second position.

The optical disk drive further comprises a switch to determine the position of the tray. The tray is received in the optical disk drive when the tray is in the first position, and is opened when the tray is in the second position. The motor rotates in a first direction while the first driving signal is applied, and rotates in a reverse second direction while the calibrating signal is applied. The first driving signal is between 4 and 6V. The reverse second driving signal is between 3 and 5V. The predetermined time period is between 0.1 and 0.5 seconds.

### BRIEF DESCRIPTION

The present invention can be more fully understood by reading the subsequent detailed description and examples with references made to the accompanying drawings which are given by way of illustration only, and thus are not limitation of the present invention, and wherein:

FIG. 1A is an exploded perspective view of a conventional optical disk drive;

FIG. 1B is a top view of a conventional optical disk drive when the tray is open;

FIG. 2A is a schematic view of the conventional optical disk drive when the tray is ejected;

FIG. 2B is a schematic view of the conventional optical disk drive when the tray is inserted;

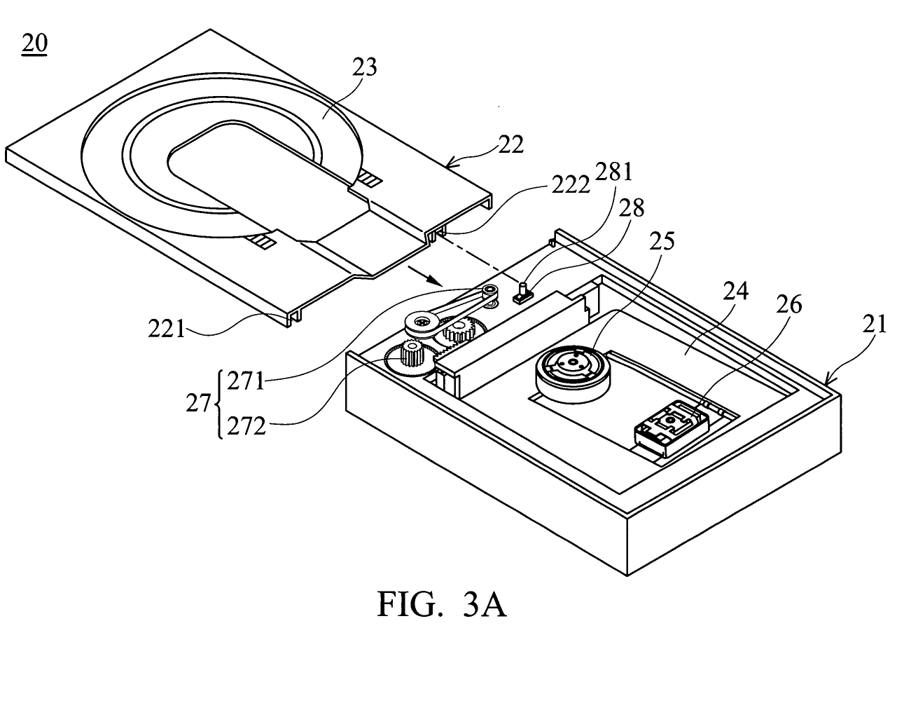

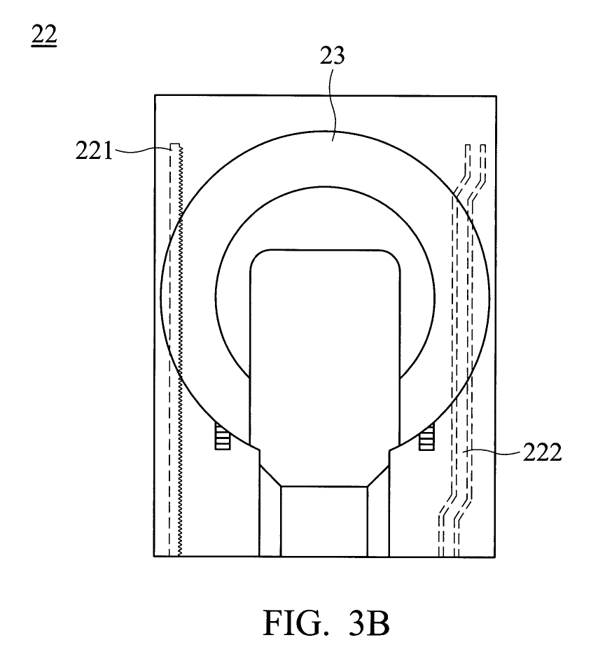

FIG. 3A is an exploded perspective view of a short optical disk drive of an embodiment of the invention;

FIG. 3B is a top view of the tray of FIG. 3A; and

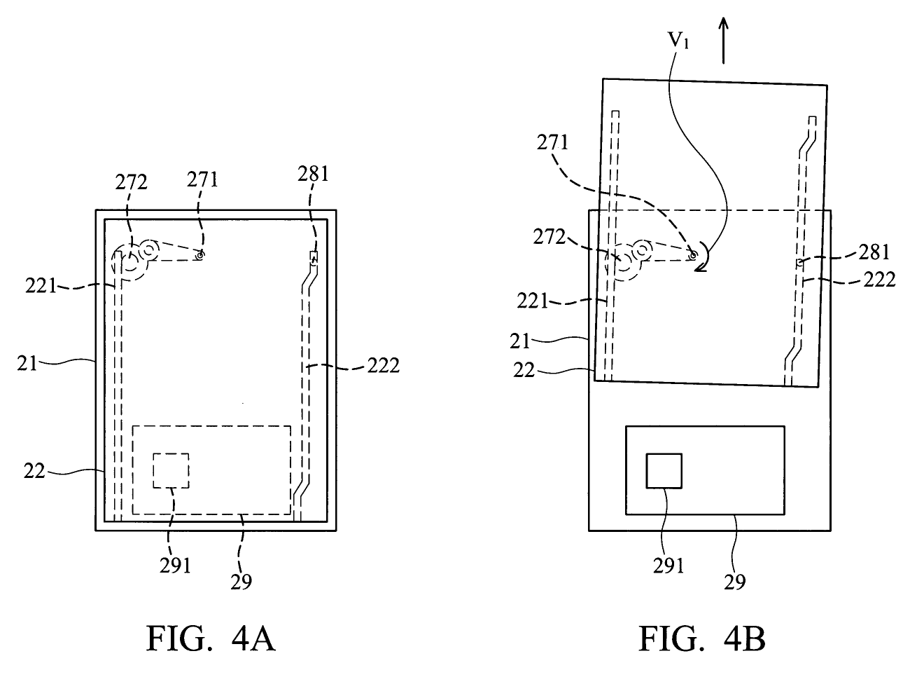

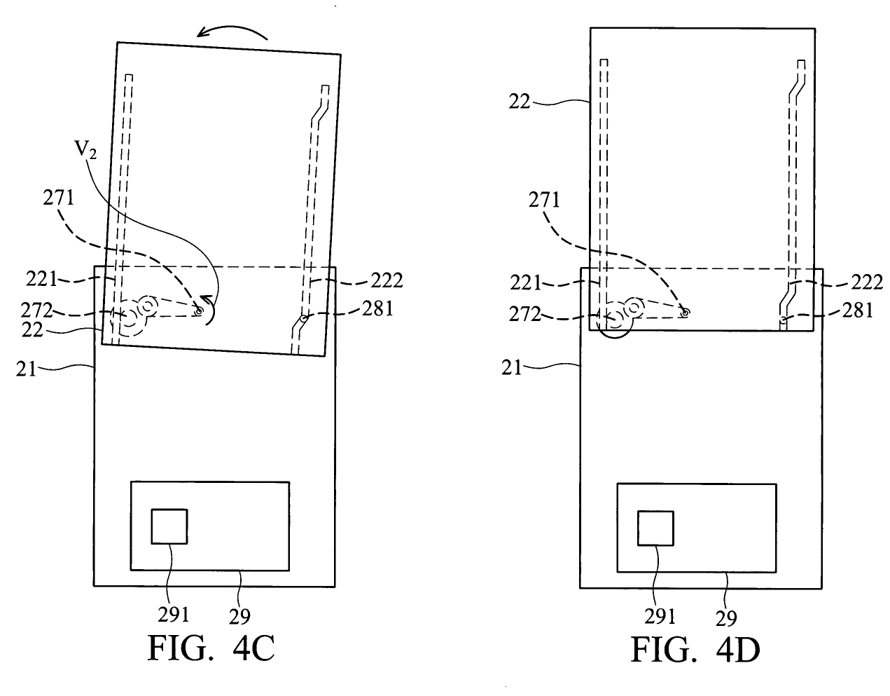

FIGS. 4A˜4D shows the positions of the switch of the short optical disk drive when the tray is ejected.

### DETAILED DESCRIPTION

FIG. 3A shows a short optical disk drive of an embodiment of the invention. In FIG. 3A, the optical disk drive 20 has a main body 21 and a tray 22. The length of the main body is between 160 and 190 mm, shorter than that of a conventional optical disk drive (190˜200 mm), to reduce required space. In FIG. 3A, the tray 22 has a recess 23 for receiving optical disks. The main body 21 of the optical disk drive 20 has a carrier 24 and a driving module 27. A spindle motor 25 and a pickup head 26 are disposed on the carrier 24. The driving module 27 comprises a motor 271, gear assembly 272, and belt 273 to drive the tray 22. After the driving module 27 moves the tray 22 holding an optical disk into the main body 21 and lifts the carrier 24, the spindle motor 25 rotates the optical disk, and data is read therefrom or written thereto by the pickup head 26.

FIG. 3B is a top view of the tray of FIG. 3A. In FIGS. 3A and 3B, the tray 21 of the optical disk drive 20 comprises a rack 221 on one side of the reverse surface. The motor 271 is capable of driving the tray 12 on one side through the gear assembly 272, belt 273, and rack 221. A switch 28 is disposed on the front of the main body 21 and is capable of determining the relative position of the tray 22 with respect to the main body 21. The tray 22 further comprises a track 222 on the reverse surface corresponding to the position of the switch 28. The track 222 is utilized to pull a protrusion 281 of the switch 28 into different operating positions when the tray 22 is ejected or inserted. Thus, the position of tray 22 can be determined according to status of the switch 28.

FIGS. 4A˜4D shows the positions of the switch of the short optical disk drive when the tray is ejected. The optical disk drive further comprises a control module 29. The control module 29 comprises a printed circuit board (PCB) and a microprocessor 291 disposed thereon. The switch 28 and motor 27 are separately connected to the PCB through wires or flexible printed circuit boards. The control module 29 of the optical disk drive can determine whether the tray 22 is in the first position, second position, or moving therebetween. The control module 29 also provides predetermined control signals of rotation direction, rotation rate, and duration to the motor 27.

In FIGS. 3A and 4A, when the tray is received in the optical disk drive 20, or the first position, and is going to be opened, the protrusion 281 of the switch 28 is restricted to a right position (first operating mode) by the track 222 of the tray 22. The microprocessor 291 of the control module 29 provides a first driving signal, or a positive bias, to the motor 271. The motor 271 rotates in a first direction V₁ and drives the tray 22 to open via the gear assembly 272 and rack 221. In FIG. 4B, as the tray 22 moving, the protrusion 281 of the switch 28 enters a middle section of the track 222 and restricted to a center position (second operating mode) The microprocessor 291 provides a larger first driving signal, or a larger positive bias, to the motor 271 according to the status of the switch 28, maintaining movement of the tray 22. The left side (active side) of the tray 22 moves faster than the right side (passive side) thereof because the tray 22 is only driven by the motor 271 on the left side. Thus, the tray 22 tilts rightward by a small angle as shown in FIG. 4B.

The microprocessor 291 stops the first driving signal when the tray 22 arrives at the second position as shown in FIG. 4C. The motor 271, however, still rotates for a short time period due to inertia, such that the protrusion 281 of the switch 28 will enter a third section of the track 222 and restricted to a left position (third operating mode). Simultaneously, the microprocessor 291 provides a calibrating signal, such as a reverse second driving signal, to the motor 271 and reverses the motor 271 for a predetermined time period. The left side of the tray 22 is inserted by a short distance during this reversing operation, and the tray 22 will swing leftward by a small correcting angle to the position as shown in FIG. 4D.

In some embodiments of the invention, the motor 271 rotates in a first direction V₁ while the first driving signal is applied, and rotates in a reverse second direction V₂ while the calibrating signal is applied. The first driving signal is between 4 and 6V. The reverse second driving signal is between 3 and 5V. The predetermined time period is between 0.1 and 0.5 second.

The control module 29 of the short optical disk drive 20 provides a calibrating signal when the tray 22 is opened to correct the horizontal tilt angle thereof. The horizontal swing problem is not apparent in the short optical disk drive 20 because the correcting operation proceeds immediately after ejection of the tray 22, and the swing angle is reduced when the tray 22 is inserted.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for reducing swing of a tray of an optical disk drive with a driving means moving the tray between a first position and a second position, comprising the steps of:
providing a first driving signal to the driving means to drive the tray from a first position to a second position; and
providing a reverse second driving signal to the driving means over a predetermined time period to correct the position of the tray when the tray arrives in the second position.

2. The method as claimed in claim 1, wherein the tray is received in the optical disk drive when the tray is in the first position.

3. The method as claimed in claim 1, wherein the tray is opened when the tray is in the second position.

4. The method as claimed in claim 1, wherein the first driving signal is between 4 and 6V.

5. The method as claimed in claim 1, wherein the reverse second driving signal is between 3 and 5V.

6. The method as claimed in claim 1, wherein the predetermined time period is between 0.1 and 0.5 seconds.

7. An optical disk drive, comprising:
a main body;
a tray disposed on the main body and movable between a first position and a second position;
a driving means for moving the tray between the first position and the second position; and
a control module providing a first driving signal to the driving means to drive the tray from a first position to a second position, and providing a reverse second driving signal to the driving means over a predetermined time period to correct the position of the tray when the tray arrives the second position.

8. The optical disk drive as claimed in claim 7, further comprising a switch to determine the position of the tray.

9. The optical disk drive as claimed in claim 7, wherein the driving means comprises a motor and a gear assembly.

10. The optical disk drive as claimed in claim 7, wherein the control module comprises a microprocessor.

11. The optical disk drive as claimed in claim 7, wherein the tray is received in the optical disk drive when the tray is in the first position.

12. The optical disk drive as claimed in claim 7, wherein the tray is opened when the tray is in the second position.

13. The optical disk drive as claimed in claim 7, wherein the first driving signal is between 4 and 6V.

14. The optical disk drive as claimed in claim 7, wherein the reverse second driving signal is between 3 and 5V.

15. The optical disk drive as claimed in claim 7, wherein the predetermined time period is between 0.1 and 0.5 seconds.

16. A method for reducing swing of a tray of an optical disk drive with a driving means moving the tray between a first position and a second position, comprising the steps of:
providing a first driving signal to the driving means to drive the tray from a first position to a second position; and
providing a calibrating signal to the driving means to correct the position of the tray when the tray arrives the second position.

17. The method as claimed in claim 16, wherein the driving means rotates in a first direction while the first driving signal is applied, and rotates in a reverse second direction while the calibrating signal is applied.
